(19) United States
(12) Patent Application Publication
(10) Pub. No.: US 2019/0027001 A1
(43) Pub. Date: Jan. 24, 2019

(54) NETWORK PORT INDICATOR

(71) Applicant: HEWLETT PACKARD ENTERPRISE DEVELOPMENT LP, Houston, TX (US)

(72) Inventor: Toby Sebastian, Bangalore (IN)

(21) Appl. No.: 15/987,866

(22) Filed: May 23, 2018

(30) Foreign Application Priority Data
May 31, 2017 (IN) 201741019196

(51) Int. Cl. G08B 5/36; H04L 12/933; H01R 13/717; H05B 33/08

(52) U.S. Cl. CPC G08B 5/36; H04L 49/10; H04L 41/12; H05B 33/0842; H01R 13/7175

(57) ABSTRACT

A device for indicating a port on a network infrastructure device. The device may receive a command, from a network manager, to identify ports associated with a first network infrastructure device. The device may also transmit a message through a high-performance computing network to the first network infrastructure device. The message may include a request to illuminate indicators corresponding, respectively, to each of the ports associated with the first network infrastructure device. Included in the requested ports are a first port of the first network infrastructure device and a second port of a second network infrastructure device.

### BACKGROUND

In high-performance computing networks, network infrastructure such as switches, routers, and bridges include a number of ports used to connect devices to the network and interconnect between one another. These ports accept networking cables or other data transmission connectors, which establish a connection between the switch, router, or bridge, and the destination device at the other terminal of the data transmission connection.

Certain network infrastructure devices also include an indicator, usually an LED light, in close proximity to the port. This indicator is used to indicate the status of the port. For example, the indicator may glow a first color to indicate that a data transmission connector has been plugged into the port, and the indicator may glow a second color to indicate that a logical connection has been made with the device at the other terminal of the data transmission connector.

### BRIEF DESCRIPTION OF THE DRAWINGS

Examples in accordance with the various features described herein may be more readily understood with reference to the following detailed description taken in conjunction with the accompanying drawings, where like reference numerals designate like structural elements, and in which:

FIG. 1A illustrates an example high-performance computing network.

FIG. 1B illustrates an example network infrastructure device of the high-performance computing network of FIG. 1A.

FIG. 2 illustrates an example interconnection of network infrastructure devices within a high-performance computing network.

FIG. 3 is a flowchart illustrating an example method for illuminating a network port.

FIG. 4 is a flowchart illustrating an example method for illuminating network ports.

FIGS. 5A-5E illustrate an example progression of a message through a high-performance computing network.

FIG. 6 is a representation illustrating an example physical configuration of the high-performance network of FIG. 5E.

FIG. 7 illustrates an example switch of a high-performance computing network.

Certain examples have features that are in addition to or in lieu of the features illustrated in the above-referenced figures.

### DETAILED DESCRIPTION

In order to perform certain types of high-performance computing tasks, multiple computing devices may be networked together to share portions of the computing tasks and perform them in parallel. Such a high-performance computing network may result in faster completion times for tasks and lower costs in comparison to an equivalent single computing device. An example high-performance computing network includes multiple computing devices, multiple network infrastructure devices configured based on a predetermined topology, and high bandwidth data connections between the devices according to the predetermined topology. For each topology, the performance of the high-performance computing network is dependent on a metric of the network (e.g. uplink-to-downlink ratio).

One example topology is the Fat-Tree topology. An example high-performance computing network configured based on a Fat-Tree topology includes two types of network infrastructure devices: leaf switches, which connect directly to the compute devices; and spine switches, which interconnect leaf switches. The example high-performance computing network's performance is dependent on an uplink-to-downlink ratio at the leaf switches (i.e. the bandwidth to the connected computing devices spine switches is a certain proportion of the bandwidth to the connected spine switches).

During setup and operation of a high-performance computing network, there are certain issues that can reduce the performance of the network. For example, multiple connections between a first network infrastructure device and a second infrastructure device may be misconnected to non-sequential ports of one or both of the network infrastructure devices, resulting in lower performance across the link between those two devices. In another example, a connection that is prescribed in the network topology may not be established during the setup of the network. In yet another example, a connection between network infrastructure devices may fail (partially or fully), resulting in reduced performance.

A network administrator, in trying to resolve issues in the setup and operation of an example high-performance computing network, may be faced with a mass of cables connecting between the devices of the high-performance computing network. Thus, it may be difficult for the administrator to, for example, identify which cables are plugged into which ports. In some example networks, the infrastructure devices and cables are indistinguishable from one another, which may make it even more difficult to identify how the cables are wired. One approach to mitigating this difficulty is to added printed or handwritten labels to devices and cables in an attempt to allow easier identification. However, such labeling may be labor intensive and prone to error.

Thus, in certain examples disclosed herein a network manager may be provided that may allow for easy and accurate identification of how cables are wired in an example network. For example, the network manager may send messages to network infrastructure devices of the network that are to cause the devices to turn on indicators associated with specific ports, thereby enabling a network administrator to easily visually identify wiring configurations of cables in the system. In particular, in certain examples the network manager may be configured to generate and send a message across the network that contains a request to enable certain indicators on certain network infrastructure devices. In example networks of this disclosure, each port of each network infrastructure device has an associated indicator (e.g. an LED light in proximity to an associated port receptacle). The message may be forwarded through the example high-performance computing network based on routing rules contained in routing tables at each network infrastructure device. At each network infrastructure device, port selection criteria may be determined from the request received in the message. The port selection criteria may be used to determine which indicators of the respective network device should be enabled. In an example network of this disclosure, the network manager can be executed on any device in the network.

For example, when a request to identify port 7 of switch 4 is received at switch 4, the switch determines that the indicator associated with port 7 should be enabled. As another example, when a request to identify all ports associated with switch 4 is received at switch 4, switch 4 determines that the indicators associated with each in-use port should be enabled. Further, when the request to identify all ports associated with switch 4 is received at switch 3, switch 3 determines that the indicators associated with ports connected to switch 4 should be enabled. In yet another example, when a request to identify all ports associated with a link between switch 3 and switch 4 is received at switch 4, switch 4 determines that the indicators associated with ports connected to switch 3 should be enabled. Further when the request to identify all ports associated with a link between switch 3 and switch 4 is received at switch 3, the switch determines that the indicators associated with ports connected to switch 4 should be enabled.

Within an example network infrastructure device, a processor is communicatively coupled to an interface. The interface includes a plurality of ports and a plurality of indicators, each associated with a respective port. Each indicator may include a LED capable of illuminating in multiple colors. Those LEDs may be controlled by an indicator driver that receives commands from a processor and illuminates each LED based on those commands. In some examples, the LED of each port illuminates amber when a physical connection is made between the respective port and another device in the high-performance computing network and illuminates green when a logical link is established across the physical connection. In an example device of the disclosure, the indicator driver illuminates the LEDs in a different color (e.g. blue) in response to a port identification request. In another example, the indicator driver illuminates the LEDs in a pattern (e.g. one-second-cycle blink) in response to a port identification request. In another example, the indicator driver illuminates dedicated port identification LEDs associated with the identified ports.

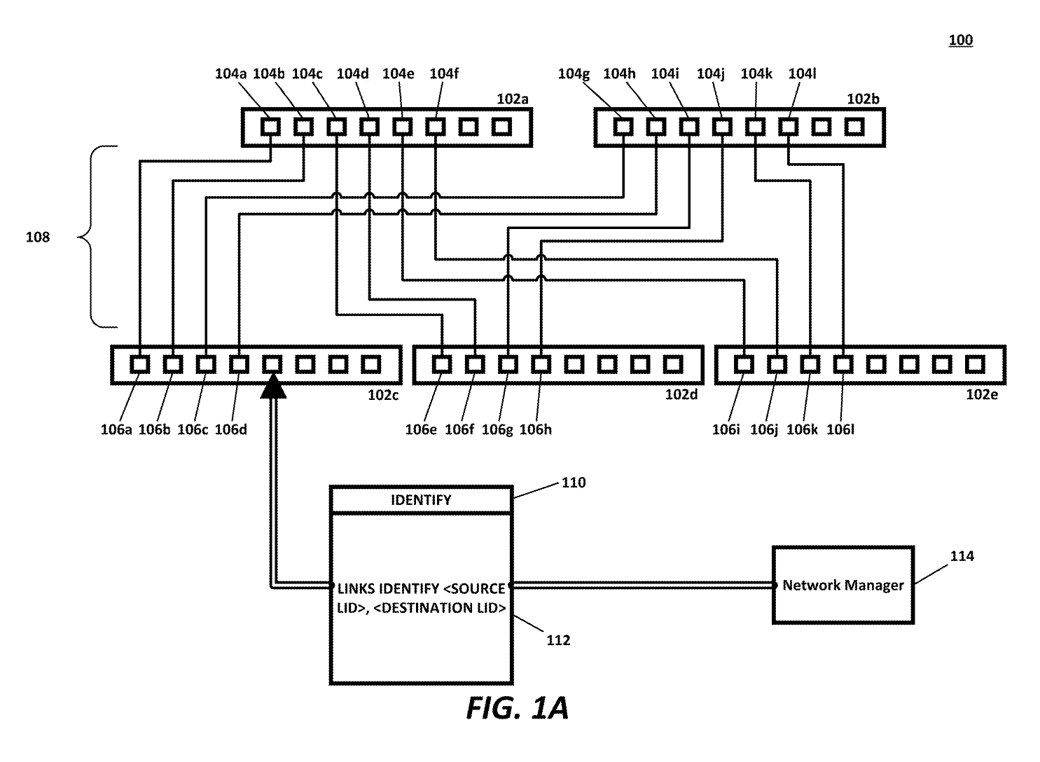

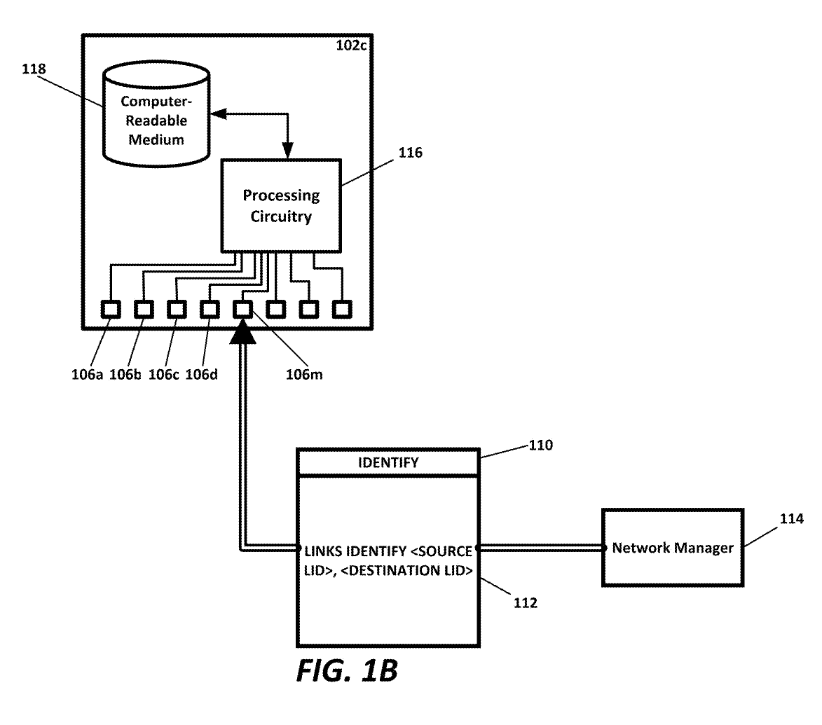

FIG. 1A illustrates an example high-performance computing network 100. In some examples, high-performance computing network 100 is interconnected through a networking fabric, such as InfiniBand. High-performance computing network 100 contains networking infrastructure 102. In certain examples, high-performance computing network 100 contains networking infrastructure devices 102. Networking infrastructure devices 102 may comprise switches, bridges, routers, and other network infrastructure devices. High-performance computing network 100 is configured based on a network topology (e.g. Fat-Tree, 4-D Cube).

For example, in a high-performance computing network 100 configured based on a Fat-Tree topology, the networking infrastructure devices 102 may include spine switches 102a-b and leaf switches 102c-d. In other examples, network infrastructure devices 102 may be known by a different nomenclature. In this disclosure, the terms “spine switch” and “leaf switch” are used in place of “network infrastructure device” where description within the context of a Fat-Tree topology is more beneficial to understanding the disclosure. The use of “spine switch” or “leaf switch” is not intended to be limiting, and can, in some examples, refer to any network infrastructure device 102. Similarly, “network infrastructure device” is not intended to be limited to switches, but refers to any appropriate network infrastructure device.

Spine switches 102a-b include ports 104. Leaf switches 102c-d include ports 106. Ports 104 and 106 may be interconnected per the topology to one of: ports on another switch and ports of a computing device (computing devices are not shown in the drawings in order to simplify the drawings). Ports 104 and 106 are interconnected via data connections 108. In certain examples, data connections 108 include electrical cables (e.g. copper cables coupled to ports 104 and 106 via a Quad Small Form-factor Pluggable connector). In some examples, data connections 108 include optical cables.

In accordance with the Fat-Tree network topology, spine switches 102a-b are connected to leaf switches 102c-e, creating links. Each link represents a logical connection between a port 104 on a spine switch 102 and a port 106 on a leaf switch 102 via a data connection 108. For example, in FIG. 1 ports 104 a-l are connected to ports 106a-l, respectively, via various connections 108. In some examples, more than one link is created between a spine switch 102 and a leaf switch 102, resulting in increased bandwidth between the two switches. For example, in FIG. 1 spine switch 102a is connected to leaf switch 102c via two data connections 108, one between port 104a and port 106a, the other between port 104b and port 106b. This disclosure does not limit the number of links between network infrastructure devices 102. Although not shown in FIG. 1A, high-speed computing network 100 may include links created between certain network infrastructure devices 102 and computing devices (not shown).

A message 110 is sent through high-performance computing network 100. In some examples, message 110 comprises one or more packets. Message 110 may be of any form appropriate for transmitting through high-performance computing network 100. In certain examples, message 110 is sent through a second management network that includes network infrastructure devices 102. Message 110 includes a request 112 to identify certain ports 104/106 in high-performance computing network 100, where the identification of a port 104/106 comprises turning on an indicator associated with the port 104/106 (such as an indicator 216). Request 112 includes information used by the network infrastructure devices 102 to generate port selection criteria. Port selection criteria may be used by the network infrastructure devices 102 that receive the message 110 to determine for which ports 104/106 identification is being requested.

The selection criteria may include any criteria from which a port 104/106 or group of ports 104/106 may be determined. For example, the selection criteria may specify a particular port(s) 104/105. In such examples, the request 112 may be interpreted by the network infrastructure device 102 receiving the request 112 as a request to identify the specified port(s) 104/106 and/or a request to activate all active ports 104/106 of the receiving network infrastructure device 102 that are associated with the specified ports 104/106. For example, request 112 may include a local ID (LID) corresponding to a network infrastructure device 102a and a port number corresponding to a port 104a of the network infrastructure device 102a. In some such examples, the network infrastructure device 102a may identify the specified port 104a in response to the request 112. In some such examples, the network infrastructure device 102c may identify the port 106a in response to the request 112 as the port 106a is connected to the specified port 104a.

As another example, the selection criteria may specify a particular network infrastructure device(s) 102 without specifying specific ports 104/106. In such examples, the request 112 may be interpreted by a receiving network infrastructure device 102 as a request to identify all active ports 104/106 of the specified network infrastructure device(s) 102 and/or all active ports 104/106 of the receiving network infrastructure device(s) 102 that are associated with the specified network infrastructure device 102. For example, request 112 may include a LID corresponding to a network infrastructure device 102a. In some such examples, the network infrastructure device 102a may identify the ports 104a-f in response to the request 112. In some such examples, the network infrastructure device 102c may identify the ports 106a and 106b in response to the request 112 as the ports 106a and 106b are connected to the specified network infrastructure device 102a. In yet another example, request 112 includes a first LID corresponding to a network infrastructure device 102a and a second LID corresponding to a network infrastructure device 102c.

In some examples, message 110 originates from network manager 114. Network manager 114 may be, for example, application instructions executed on a network device. A network device may be a network infrastructure device 102, a computing device, a network management device, or any other device appropriate for interconnecting to high-performance computing network 100. In other examples, network manager 114 may be operating system utility instructions executed on a network device. In yet other examples, network manager 114 may be a network-connected hardware device. Network manager 114 may send other messages through the high-performance computing network 100 and generate topology information based on received responses from network devices in response to the other messages. For example, network manager 114 may include a command-line based tool (e.g. ibnetdiscover) that allows a network administrator to request network topology information.

In certain examples, network manager 114 generates message 110 in response to receiving a command from a network administrator to identify certain ports within high-performance computing network 100. In certain other examples, network manager 114 automatically generates message 110 based on a pre-determined command. Network manager 114 may generate message 110 in response a timer or in response to a detected network condition.

For example, network manager 114 may receive a command to identify certain particular port numbers of particular network infrastructure devices 102. For example, network manager 114 may receive a command of the format “DATA PORT IDENTIFY <LID>-<portNurn>, <LID>-<portNum>” to identify specific ports 104 and 106 of specific network infrastructure devices 102 (e.g. “DATA PORT IDENTIFY 2-3, 5-2” to identify port 104i of network infrastructure device 102b and port 106j of network infrastructure device 102e).

In another example, network manager 1:1.4 may receive a command to identify all links associated with a particular network infrastructure device 102. For example, network manager 114 may receive a command of the format “LINKS IDENTIFY <LID>” to identify all in-use ports 104 and 106 associated with a specific network infrastructure device 102 (e.g. “LINKS IDENTIFY 5” to identify all in-use ports associated with network infrastructure device 102e, which, in FIG. 1A, include ports 104e-f, 104k-l, and 106i-l).

In yet another example, network manager 114 may receive a command to identify all links between a first network infrastructure device 102 and a second network infrastructure device 102. For example, network manager 114 may receive a command of the format “LINKS IDENTIFY <LID>, <LID>” to identify all in-use ports 104 and 106 associated with links between the first network infrastructure device 102 and the second network infrastructure device 102 (e.g. “LINKS IDENTIFY 1,4” to identify all in-use ports associated with links between network infrastructure device 102a and network infrastructure device 102d, which, in FIG. 1A, include ports 104c-d, and 106e-f).

In some examples, upon receiving a command, network manager 114 generates message 110 and creates request 112 to include port selection criteria based on the received command. For example, request 112 shown in FIG. 1A includes port selection criteria corresponding to a command “LINKS IDENTIFY <SOURCE LID>, <DESTINATION LID>.” The port selection criteria of the request need not be an exact duplication of the received command, but may be in any format acceptable to the network infrastructure devices 102 such that the network infrastructure devices 102 determine which ports 104 and 106 to identify via their respective indicators.

Message 110 is received by a network infrastructure device 102 to which network manager 114 (or the device on which network manager 1:1.4 resides) is connected. For example, in FIG. 1A, message 110 may be received on one of the ports 106 of network infrastructure device 102c. Message 110 is not restricted to being received at any certain network infrastructure devices 102, but may be received at any port of any network infrastructure device 102. In certain examples where message 110 is sent through a separate management network, message 110 may be received at a management port (not illustrated) of a network infrastructure device 102.

The message 110 may enable a user (e.g., a network administrator) to visually identify cabling configurations of the network 100 (e.g., which ports 104 are connected to which ports 106) by causing indicators of specified ports 104/106 to be turned on. This may make it easier for the user to diagnose and/or correct problems in the network 100. For example, the message 110 may be particularly useful in helping to diagnose and/or correct cabling errors (“miscabling”), failures of connections 108, and the like.

For example, in an example high-performance computing network 100, a network administrator may miscable the network 100, resulting in a reduction in performance. For example, the network administrator could place multiple data connections 108 between network infrastructure device 102a and network infrastructure device 102c into non-adjacent ports (e.g. links between network infrastructure device 102a and network infrastructure device 102c are connected to ports 106a and 106c, but not 106b of network infrastructure device 102c). As another example, a data connection 108 intended to link between network infrastructure device 102a and network infrastructure device 102c could instead be miscabled between network infrastructure device 102a and network infrastructure device 102d, resulting in reduced performance. Depending on the topology of the high-performance computing network 100, different miscabling errors may result in different magnitudes of reduced performance. As noted above, absent some intervention it may be difficult to determine which cables have been connected to which ports 104/106. Thus, when miscabling has occurred, it may be difficult to determine the cause of the reduced performance and the data connection 108 corresponding to the reduced performance. However, in examples disclosed herein, as a result of network manager 114 generating and sending message 110 into miscabled network 100, indicators are enabled corresponding to the identified ports 104 and 106 of the network infrastructure devices 102, which may make it easier to determine where the miscabling has occurred.

As another example, in another example high-performance computing network 100, a data connection 108 has failed. This failure may be partial (resulting in reduced bandwidth through the corresponding link) or full (resulting in no communication through the corresponding link). Like in the miscabling example, it is difficult to determine the cause of the reduced performance and the data connection 108 corresponding to the reduced performance. However, in examples disclosed herein, as a result of network manager 114 generating and sending message 110 into network 100 with a failed data connection 108, indicators are enabled corresponding to the identified ports 104 and 106 of the network infrastructure devices 102, which can be used to determine where the failure has occurred.

In FIG. 1B, an example network infrastructure device of the high-performance computing network 100 of FIG. 1A is shown. Network infrastructure device 102c includes ports 106, which in the example of FIG. 1B may include ports 106a-d and 106m. Ports 106a-d may be connected to network infrastructure devices (e.g., network infrastructure devices 102a-b in FIG. 1A). In the example illustrated in FIG. 1B, the port 106m receives message 110 containing request 112. Message 110 is generated and sent from network manager 114. Ports 106 are coupled to processing circuitry 116.

Processing circuitry 116 may include processors, ASICs (Application Specific Integrated Circuits), FPGAs (Field Programmable Gate Arrays), and any other processing circuitry appropriate for a network infrastructure device 102. Processing circuitry 116 is coupled to computer-readable medium 118. Computer-readable medium 118 may include flash memory chips, HDDs (Hard Disk Drives), SSD (Solid State Drives and any other computer-readable media appropriate for a network infrastructure device 102. In some examples, computer-readable medium 118 includes instructions that, when executed by processing circuitry 116, receive message 110, reading port selection criteria from request 112 of message 110, determine which ports 106 are identified by the port selection criteria in request 112, enable indicators associated with the identified ports 106, and forward message 110 based on network topology information.

For example, network infrastructure device 102c may receive a message 110 containing a request 112 to identify all ports associated with LID-1 (e.g. request 112 corresponds to command “LINKS IDENTIFY 1”). Processing circuitry 116 executes instructions from computer-readable medium 118, resulting in processing circuitry 116 receiving message 110, reading request 12 to identify all ports associated with LID-1, and determining that ports 106a-b are associated with LID-1 (for example, network infrastructure device 102a in FIG. 1A). Then, processing circuitry 116 executes instructions to enable indicators (not shown) associated with ports 106a-b and forwards, based on network topology information (e.g. a routing table), message 110 through port 106c.

Although the above example describes message 110 being received on a port 106m that is not identified by the port selection criteria and message 110 being forwarded through a port 106c that is not identified by the port selection criteria, this disclosure is not limited to that example. Message 110 can be received on any port 106 and forwarded through any port 106, regardless of whether or not the port is identified in the port selection criteria. Message 110 can also be received and forwarded “out of band” at a management port in examples containing a separate management network, in which case the port 106m may correspond to the management port.

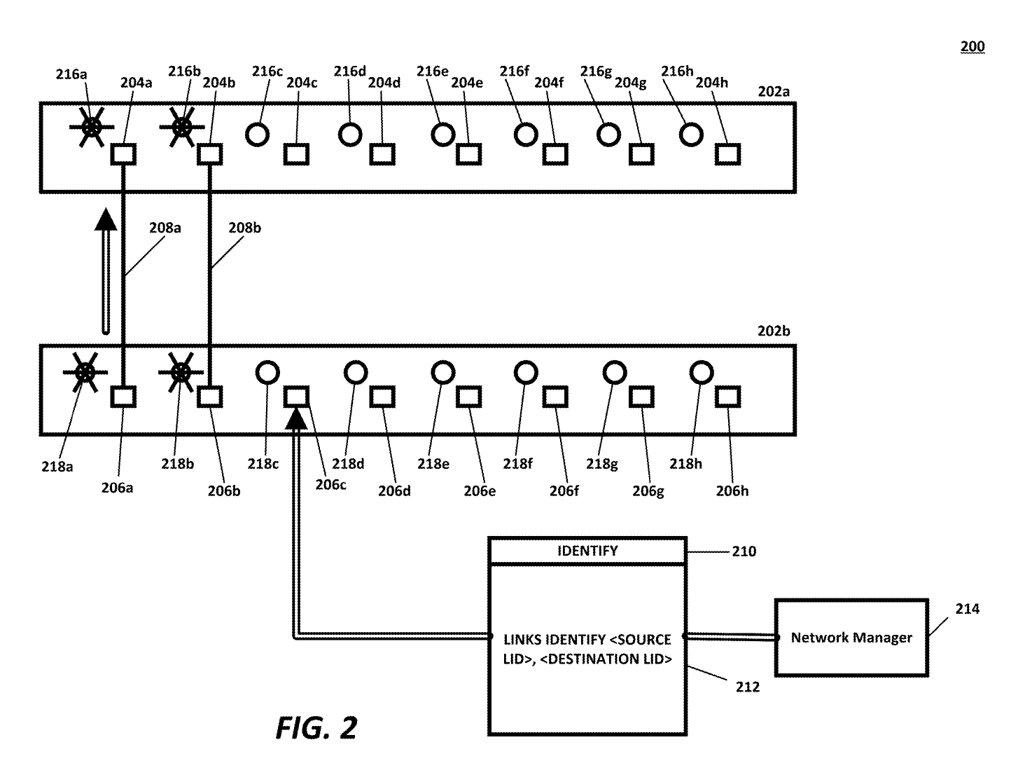

FIG. 2 shows an example interconnection of network infrastructure devices 202 within a high-performance computing network 200. In some examples, high-performance computing network 200 contains more network infrastructure devices 202 than the two shown in FIG. 2. For example, FIG. 2 may be a portion of a high-performance computing network 200 consistent with FIG. 1A.

Network infrastructure device 202a includes ports 204a-h and indicators 216a-h. Each indicator 216 is associated with a respective port 204. As illustrated in FIG. 2, indicator 216a is associated with port 204a, and indicators 216 are associated with similarly labeled ports 204 such that the indicator 216 is located above and to the left of the corresponding port 204. Indicators 216 are represented as circles, and enabled indicators 216 are represented as circles with radiating lines (e.g. indicators 216a-b). Although indicators 216 are represented as a light being illuminated, indicators 216 may be enabled in any appropriate manner, including changing color, changing shape, blinking, moving, or otherwise being altered in a way that indicates the corresponding port 204.

Similarly, network infrastructure device 202b includes ports 206a-h and indicators 218a-h. Like described in relation to network infrastructure 202a, indicators 218 are shown in FIG. 2 above and to the left of their corresponding ports 206. Indicators 218 are represented as circles, and enabled indicators 218 are represented as circles with radiating lines (e.g. indicators 218a-b). Although indicators 218 are represented as a light being illuminated, indicators 218 may be enabled in any appropriate manner, including changing color, changing shape, blinking, moving, or otherwise being altered in a way that indicates the corresponding port 206.

In some examples, network infrastructure device 202a and network infrastructure device 202b are coupled by data connections 208a-b between ports 204a-b and 206a-b, respectively. Each data connection 208a-b creates a link between network infrastructure device 202a and network infrastructure device 202b. Certain examples may contain additional data connections 208 between network infrastructure device 202a and network infrastructure device 202b. However, for the sake of clarity, the number of data connections 208 shown in FIG. 2 is limited to two. Other data connections 208 (not shown) may be connected to ports of network infrastructure device 202a or network infrastructure device 202b. Such other data connections 208 are omitted from FIG. 2 for the sake of clarity.

Message 210 including request 212 is generated and sent from network manager 214. Network manager 214 may be located at any point in the network. In the examples illustrated in FIG. 2, network manager 214 is coupled to port 206c of network infrastructure device 202b. For example, network manager 214 may reside on a computing device (not shown) coupled to port 206c through a data connection 208 (not shown). In another example, network manager 214 may consist of a device directly connected to port 206c. In yet another example, network manager 214 may reside on a network infrastructure device 202 (not shown) coupled to port 206c through a data connection 208 (not shown). Network manager 214 may be any combination of hardware, software, and firmware appropriate to manage high-performance computing network 200. Message 210 may also be forwarded from network infrastructure device 202b through data connection 208a (indicated by the double-lined arrow to the left of data connection 208a). In some examples, network infrastructure device 202b determines, based on network topology information (e.g. a routing table), that message 210 should be forwarded through port 206a.

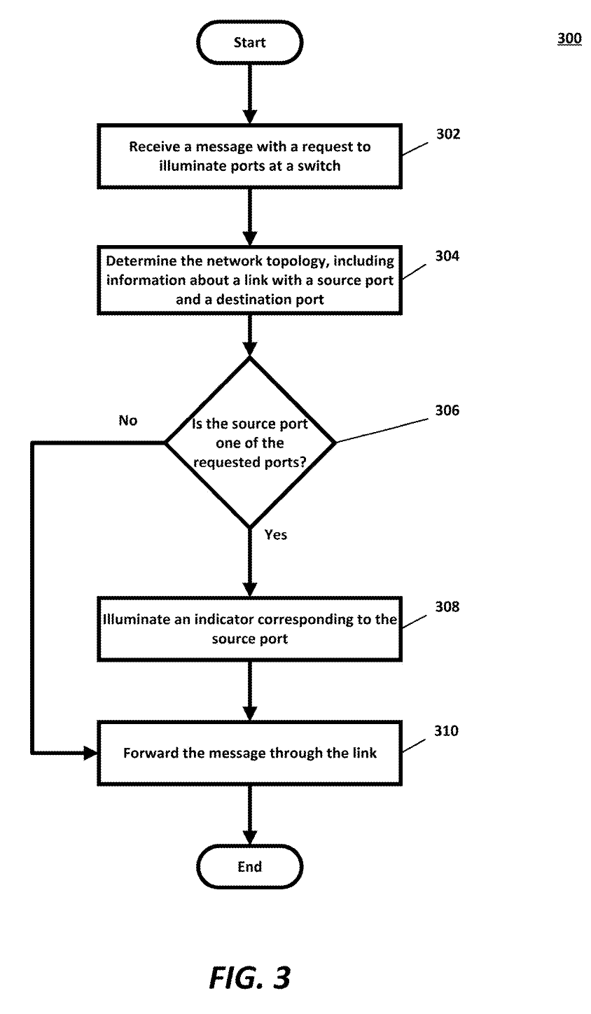

FIG. 3 illustrates a flowchart of an example method 300 for illuminating indicators. In step 302, a message is received. The message includes within it a request to illuminate ports at a switch. For example, the message may include a request based on a command “LINKS IDENTIFY <LID>”, which requests all in-use ports of switch <LID> be illuminated, along with all ports on network devices throughout the high-performance computing network that are coupled to ports of switch <LID>. In another example, the message may include a request based on a command “LINKS IDENTIFY <SOURCE LID>, <DESTINATION LID>”, which requests all ports of switch <SOURCE LID> that are coupled to <DESTINATION LID> be illuminated, along with all ports on <DESTINATION LID> that are coupled to ports of switch <SOURCE LID>. In yet another example, the message may include a request based on a command “DATA PORT IDENTIFY <LID>, <Port Num>”, which requests port <Port Num> of switch <LID> be illuminated. In some examples, the message is received at a switch that includes ports that are requested to be illuminated. In some other examples, the message is received at a switch or other network infrastructure device that does not include any ports that are requested to be illuminated.

In some examples, the message is received at an interface of the switch through a port. The message is forwarded from the port to processing circuitry that, based on executing instructions from a computer-readable medium, processes the message. In processing the message, the processing circuitry generates port selection criteria to be applied to each port of the switch in determining which indicators of which ports to illuminate.

In step 304, the switch receives information regarding a topology of the high-performance computing network. In some examples, the topology is determined by a network manager. The topology may be stored in a routing table or any other data structure appropriate for containing a network topology. The topology contains information about links between network infrastructure devices, including links between the switch and network infrastructure devices. The information about each link contains information about a first port and a second port. In some examples, links are bidirectional, and each link is represented by two entries in the topology, one for each direction. In some other examples, links are unidirectional, and each link is represented by one entry in the topology. In this disclosure, when a link couples the switch to a network infrastructure device (a local link), the first port and the second port are referred to as a source port (the port of the switch) and a destination port (the port of the network infrastructure device).

In step 306, the switch compares the port selection criteria to the information about a local link to determine whether the source port of the local link is selected for illumination. For example, the port selection criteria may request illumination of all ports coupled to switch LID-3. Switch LID-1 compares information on a local link with source port 4 to the port selection criteria. In the examples where the local link is coupled to a port of switch LID-3, the switch determines that source port 4 is one of the requested ports. In the examples where the local link is coupled to a port of a switch other than LID-3, the switch determines that source port 4 is not one of the requested ports.

In step 308, the switch, upon determining that a source port is one of the requested ports, illuminates an indicator corresponding to the source port. In some examples, processing circuitry of the switch sends a message to the source port commanding the source port to illuminate the indicator. In some other examples, the processing circuitry is directly coupled to the indicator, and illuminates the indicator without sending a message to the source port. Although the term “illuminate” is used in certain places in this disclosure relating to the indicator, it is contemplated that the indicator could perform any action appropriate for indicating a port.

In step 310, the switch determines, based on the topology and the received message that the message should be forwarded through the link. The switch then forwards the message through the link. In some examples, the switch forwards the message through multiple local links. In forwarding the message, the switch may encapsulate the message in a packet. The switch may also alter information in the message to indicate that the message has been received by the switch. The switch may also alter the message to include portions of the port selection criteria so that network infrastructure devices that receive the message after the switch do not have to generate their own port selection criteria. In some other examples, the port selection criteria of the switch includes information useful only to the switch, and the switch does not alter the message to include portions of the port selection criteria.

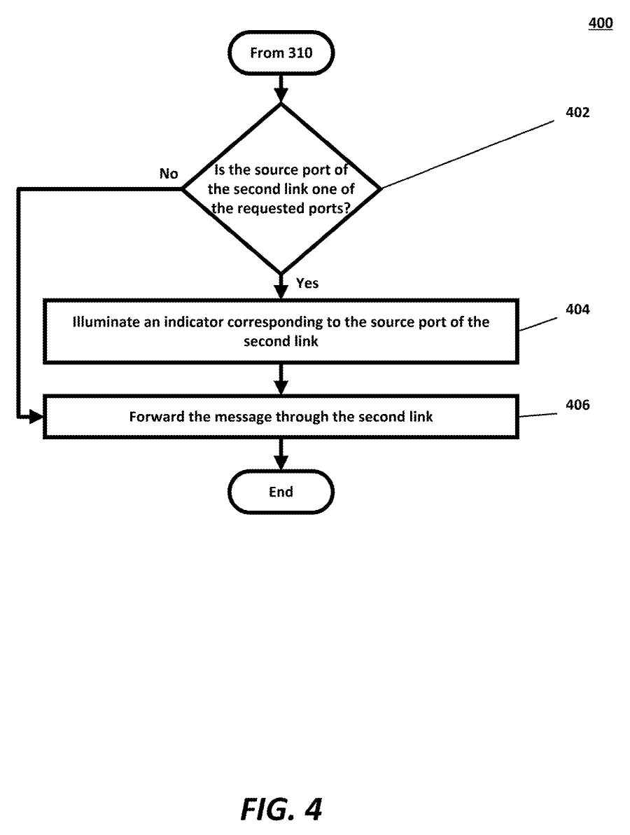

FIG. 4 is a flowchart of an example method that may be executed after step 310 of method 300. In some examples, method 400 may be executed prior to step 310 so that when the source port is not one of the requested ports in step 306, step 402 is then executed. Method 400 illuminates an indicator of a source port of a second link if the source port of the second link is requested to be illuminated.

In step 402, the switch compares the port selection criteria to the information about a second local link to determine whether the source port of the second local link is selected for illumination. For example, the port selection criteria may request illumination of all ports coupled to switch LID-3. Switch LID-1 compares information on a second local link with source port 5 to the port selection criteria. In the examples where the second local link is coupled to a port of switch LID-3, the switch determines that source port 5 is one of the requested ports. In the examples where the second local link is coupled to a port of a switch other than LID-3, the switch determines that source port 5 is not one of the requested ports.

In step 404, the switch, upon determining that a source port of the second local link is one of the requested ports, illuminates an indicator corresponding to the source port. In some examples, processing circuitry of the switch sends a message to the source port commanding the source port to illuminate the indicator. In some other examples, the processing circuitry is directly coupled to the indicator, and illuminates the indicator without sending a message to the source port. Although the term “illuminate” is used in certain places in this disclosure relating to the indicator, it is contemplated that the indicator could perform any action appropriate for indicating a port.

In step 406, the switch determines, based on the topology and the received message that the message should be forwarded through the second link. The switch then forwards the message through the second link. In some examples, the switch forwards the message through multiple local links. In forwarding the message, the switch may encapsulate the message in a packet. The switch may also alter information in the message to indicate that the message has been received by the switch. The switch may also alter the message to include portions of the port selection criteria so that network infrastructure devices that receive the message after the switch do not have to generate their own port selection criteria. In some other examples, the port selection criteria of the switch includes information useful only to the switch, and the switch does not alter the message to include portions of the port selection criteria.

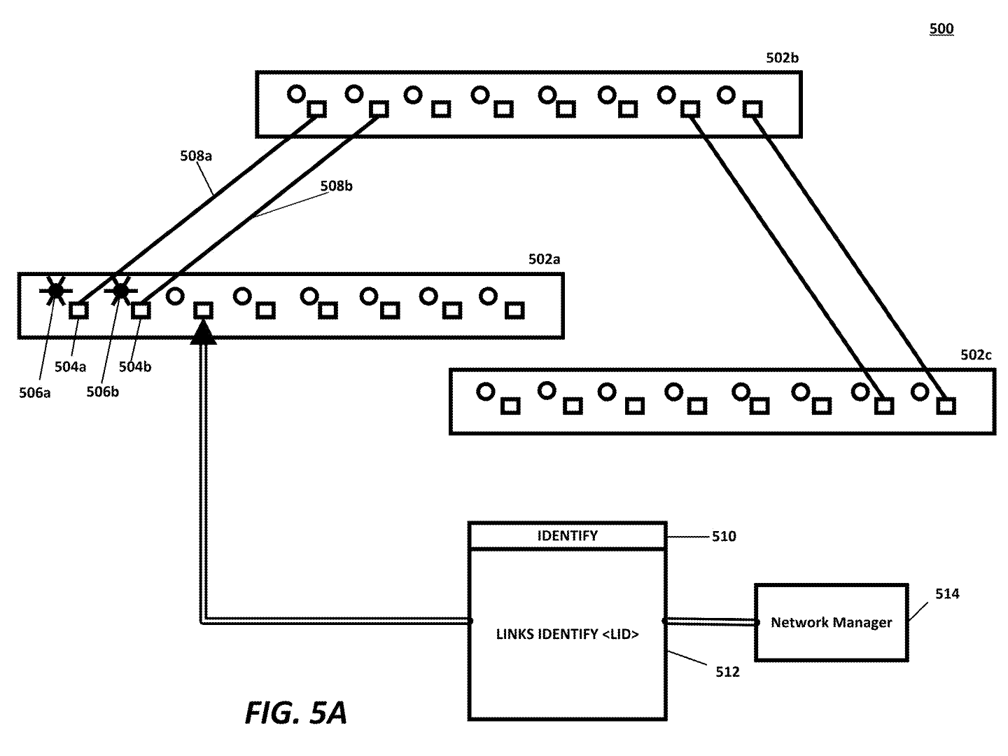

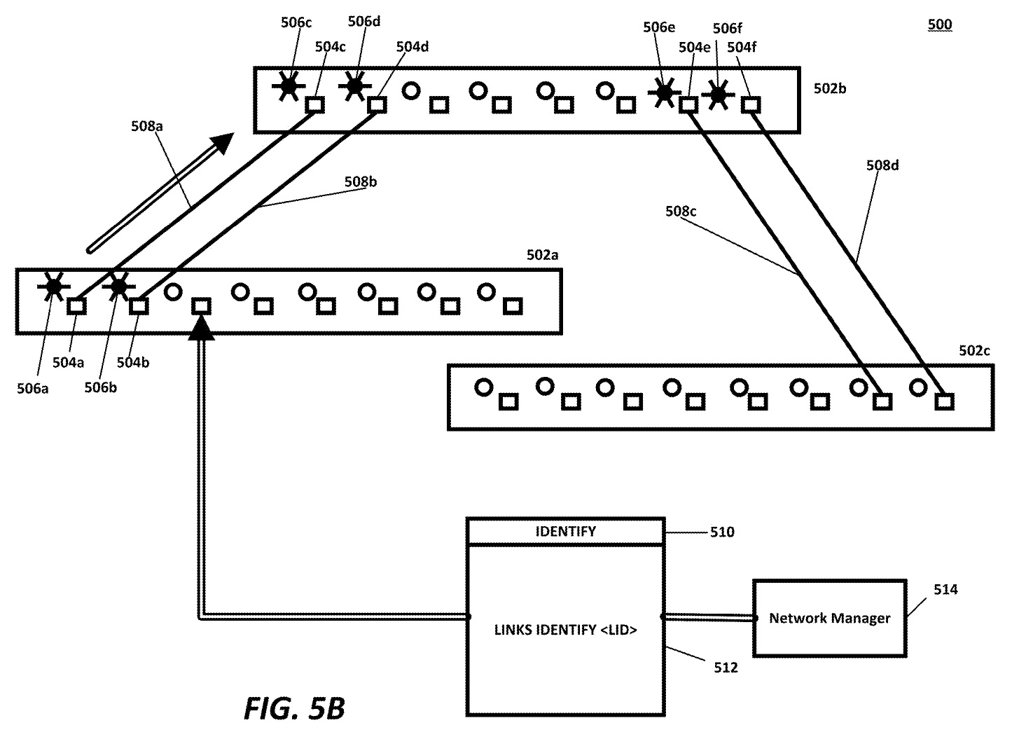

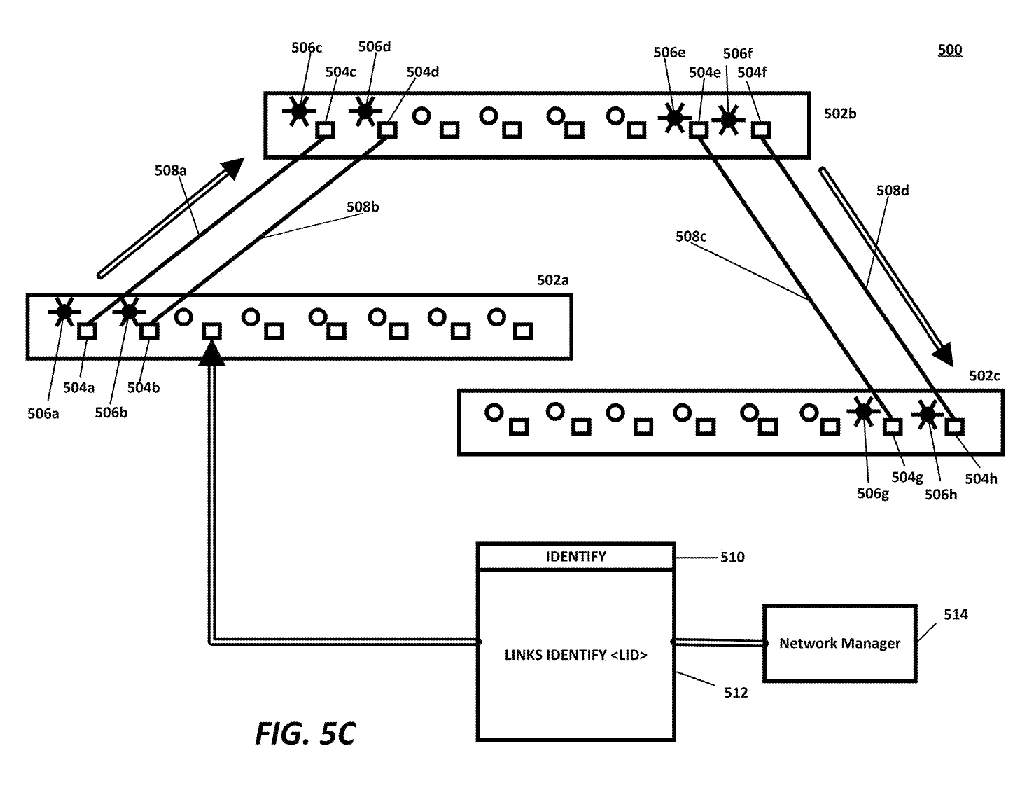

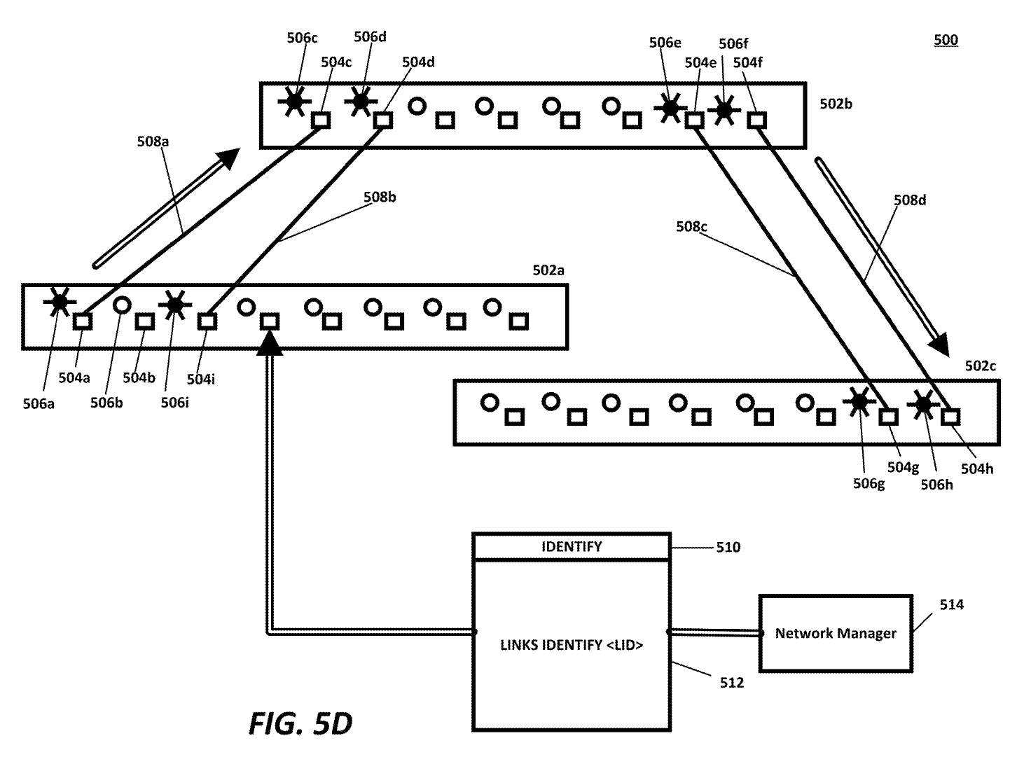

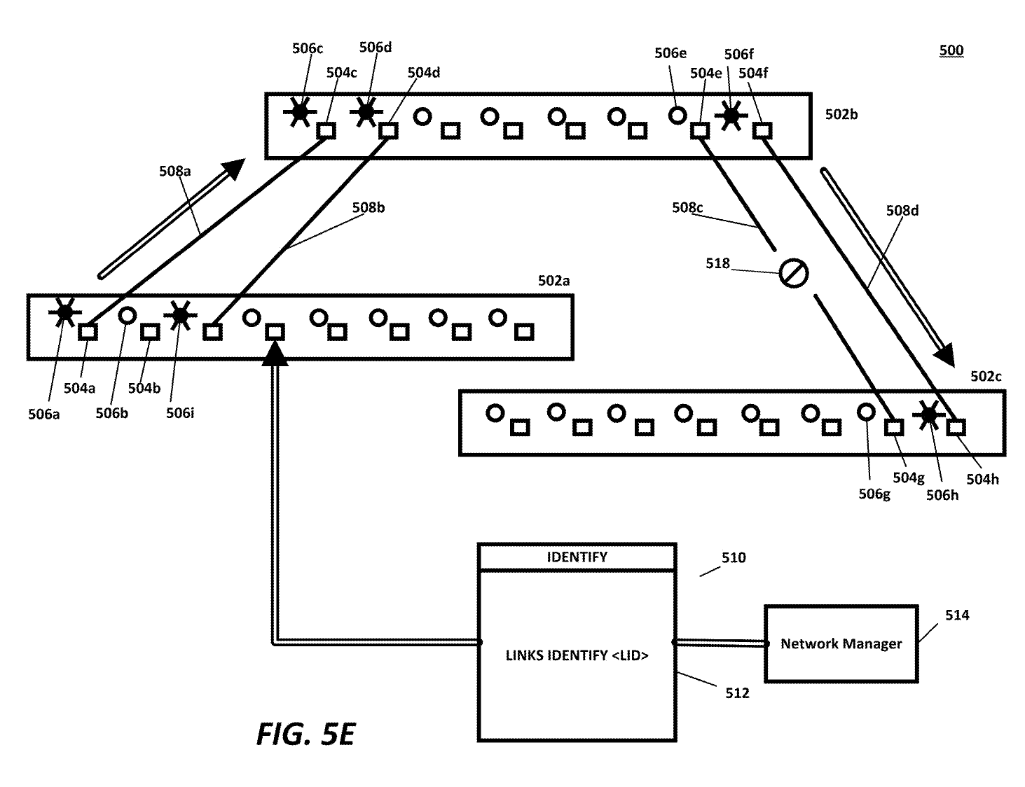

FIGS. 5A-E illustrate an example high-performance computing network 500. In FIGS. 5A-E, high-performance computing network 500 is illustrated in a simplified form, only showing three (3) network infrastructure devices 502. FIGS. 5A-E show the progression of a message 510 through high-performance computing network 500 as each network infrastructure device 502 receives and processes the message. In some of FIGS. 5A-E, common issues that befall high-performance computing networks 500, such as miscabling and broken links, are shown. For clarity, only certain examples of components of high-performance computing network 500 are labeled in each of FIGS. 5A-E.

FIG. 5A illustrates an example high-performance computing network receiving a message at a network infrastructure device. High-performance computing network 500 includes network infrastructure devices 502. In some examples, network infrastructure devices 502 are configured in a Fat-Tree topology, where network infrastructure device 502b is a spine switch and network infrastructure devices 502a and 502c are leaf switches. Network infrastructure devices 502 include ports 504. Each port 504 corresponds to a respective indicator 506. Ports 504 are interconnected with other ports 504 through data connections 508. In some examples, ports 504 are a logical entity, comprising a data terminal and software to receive and process data received at the data terminal. Interconnected ports 504, along with a data connection 508 between the interconnect ports 504, comprise a link. For the purposes of this disclosure, when referring to a local link from the point of view of a network infrastructure device 502, a port 504 of the link that is also of network infrastructure device 502 is considered a “source port” and a port 504 of the link that is not of network infrastructure device 502 is considered a “destination port.” For the purposes of this disclosure, links are referred to based on the label associated with their respective data connections 508. For example, the link including port 504a and data connection 508a may be referred to as link 508a. Network infrastructure device 502a is interconnected to network infrastructure device 502b through links 508a and 508b. Network infrastructure device 502a includes source ports 504a and 504b of links 508a and 508b, respectively.

Network infrastructure device 502a receives a message 510 at a port 504 (not labeled in FIG. 5A). Message 510 contains a request 512. Message 510 is generated and sent from network manager 514 as described in relation to FIGS. 1A-B. Upon receiving message 510, network infrastructure device 502a processes message 510 and generates port selection criteria based on request 512. Network infrastructure device 502a compares the port selection criteria to a network topology to determine which ports 504 of network infrastructure device 502a are requested to be identified by request 512. For example, message 510 may include a request 512 to identify all ports associated with network infrastructure device 502b. Network infrastructure device 502a, uses a network topology to determine that links 508a and 508b interconnect network infrastructure device 502a to network infrastructure device 502b. Therefore, ports 504a and 504b of links 508a and 508b, respectively, are associated with network infrastructure device 502b, and are requested to be identified. Network infrastructure device 502a, in response to request 512, then illuminates indicators 506a and 506b, which are associated with ports 504a and 504b, respectively.

In FIG. 5B, the message propagates through the high-performance computing network to more network infrastructure devices 502. Network infrastructure device 502a determines, based on the network topology, that message 510 should be forwarded through high-performance computing network 500. Network infrastructure device 502a determines a link to forward message 510 through and forwards message 510. For example, network infrastructure device 502a determines, based on the network topology, that it should forward message 510 through link 508a to network infrastructure device 502b. Network infrastructure device 502a then prepares message 510 to be sent through link 508a, and forwards the message to network infrastructure device 502b.

Network infrastructure device 502b receives a message 510 at port 504c. Upon receiving message 510, network infrastructure device 502b processes message 510 and generates port selection criteria based on request 512. Network infrastructure device 502b compares the port selection criteria to a network topology to determine which ports 504 of network infrastructure device 502b are requested to be identified by request 512. For example, message 510 may include a request 512 to identify all ports associated with network infrastructure device 502b. Network infrastructure device 502b uses a network topology to determine that links 508a, 508b, 508c, and 508d interconnect network infrastructure device 502b to network infrastructure devices 502a and 502c. Therefore, ports 504c, 504d, 504e, and 504f of links 508a, 508b, 508c, and 508d, respectively, are associated with network infrastructure device 502b, and are requested to be identified. Network infrastructure device 502b, in response to request 512, then illuminates indicators 506c, 506d, 506e, and 506f, which are associated with ports 504c, 504d, 504e, and 504f, respectively.

In FIG. 5C, the message further propagates through the high-performance computing network to even more network infrastructure devices. Network infrastructure device 502b determines, based on the network topology, that message 510 should be forwarded through high-performance computing network 500. Network infrastructure device 502b determines a link to forward message 510 through and forwards message 510. For example, network infrastructure device 502b determines, based on the network topology, that it should forward message 510 through link 508d to network infrastructure device 502c. Network infrastructure device 502b then prepares message 510 to be sent through link 508d, and forwards the message to network infrastructure device 502c.

Network infrastructure device 502c receives a message 510 at port 504h. Upon receiving message 510, network infrastructure device 502c processes message 510 and generates port selection criteria based on request 512. Network infrastructure device 502c compares the port selection criteria to a network topology to determine which ports 504 of network infrastructure device 502c are requested to be identified by request 512. For example, message 510 may include a request 512 to identify all ports associated with network infrastructure device 502b. Network infrastructure device 502c uses a network topology to determine that links 508c and 508d interconnect network infrastructure device 502c to network infrastructure device 502b. Therefore, ports 504g and 504h of links 508c and 508d, respectively, are associated with network infrastructure device 502b, and are requested to be identified. Network infrastructure device 502c, in response to request 512, then illuminates indicators 506g and 506h, which are associated with ports 504g and 504h, respectively.

FIG. 5D illustrates the high-performance computing network of FIG. 5C with a miscabling network issue. Rather than having links 508a and 508b terminate at adjacent ports on network infrastructure device 502a, Link 508a terminates at port 504a, and link 508b terminates at port 504i, with intervening port 504b in between ports 504a and 504i. As explained in relation to FIGS. 1A-B, miscabling may reduce performance of high-performance computing network 500.

In contrast to FIGS. 5A-5C, network infrastructure device 502a, upon receiving message 510, has not illuminated indicators 506a and 506b. Instead, network infrastructure device 502a has illuminated indicators 506a and 506i. In combination with a network topology, these noncontiguous illuminated indicators can be used to determine that a miscabling has occurred.

FIG. 5E illustrates the high-performance computing network of FIG. 5D with a broken link network issue. Rather than having two links 508c and 508d between network infrastructure devices 502b and 502c, link 508c has a break 518. In some examples, break 518 is a complete disconnection of link 508c. In some other examples, break 518 still allows data to pass through link 508c, but at a significantly reduced bandwidth.

In contrast to FIGS. 5A-5D, network infrastructure devices 502b and 502c each, upon receiving message 510, have not illuminated indicators 506e and 506g, respectively. In combination with a network topology, these unilluminated indicators 506e and 506g can be used to determine that link 508c has broken 518.

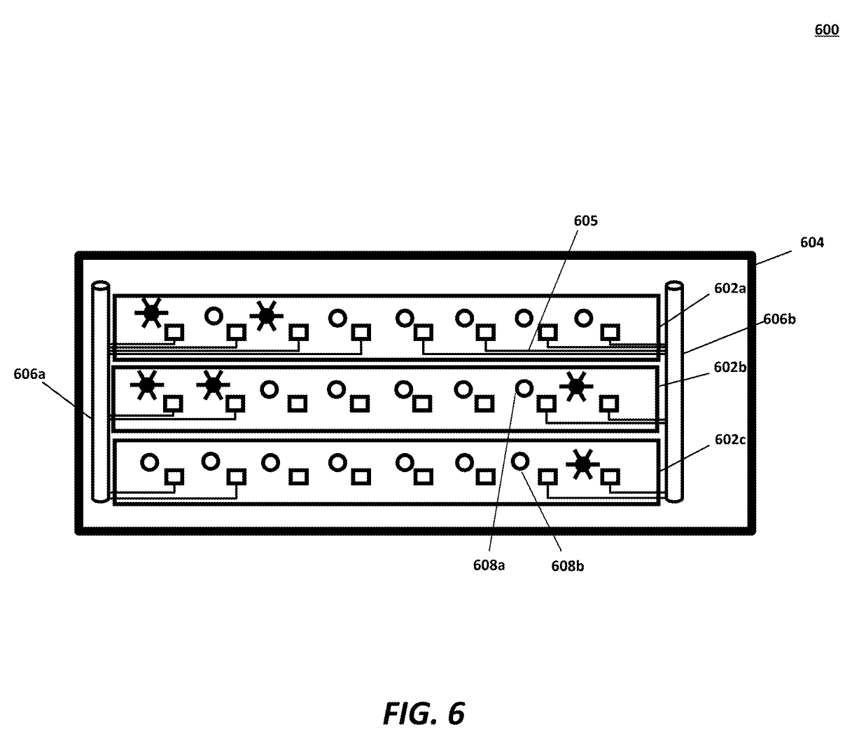

FIG. 6 is an illustration of a front rack view of the high-performance computing network of FIG. 5D, including the miscabling and the broken link. Network infrastructure devices 602 correspond to the same respective network infrastructure devices 502. Components of high-performance computing network 600 may be contained in a rack 604. Rack 604 may provide power and other amenities to components of high-performance computing network 600. Network infrastructure devices 602 are mounted within rack 604. In some examples, network infrastructure devices 602 are mounted adjacent to one another. In some other examples, intervening gaps separate network infrastructure devices 602.

Network infrastructure devices 602 are interconnected based on a network topology through data connections 605. Certain data connections 605 interconnect one network infrastructure device 602 to another network infrastructure device 602. Certain other data connections 605 interconnect a network infrastructure device 602 to a computing device. In FIG. 6, only network infrastructure device 602a is shown with data connection 605 between network infrastructure device 602a and computing devices. For clarity, such data connections 605 are omitted from network infrastructure devices 602b and 602c. Data connections 605 are routed to the sides of rack 604 into cable bundles 606a-b. In some examples, cable bundles 606a-b are merely a large number of data connection 605 routed in parallel. In some other examples, cable bundles 606a-b are held together with bundling components (e.g. cable sleeve, cable conduit, zip ties).

With indicators of each network infrastructure device 602 illuminated, networking issues can be determined. For example, the left three indicators of network infrastructure device 602a indicate the miscabling issue discussed in relation to FIG. 5D. As another example, the unilluminated indicator second from the right on network infrastructure device 602b and the unilluminated indicator second from the right on network infrastructure device 602c indicate the broken link discussed in relation to FIG. 5E.

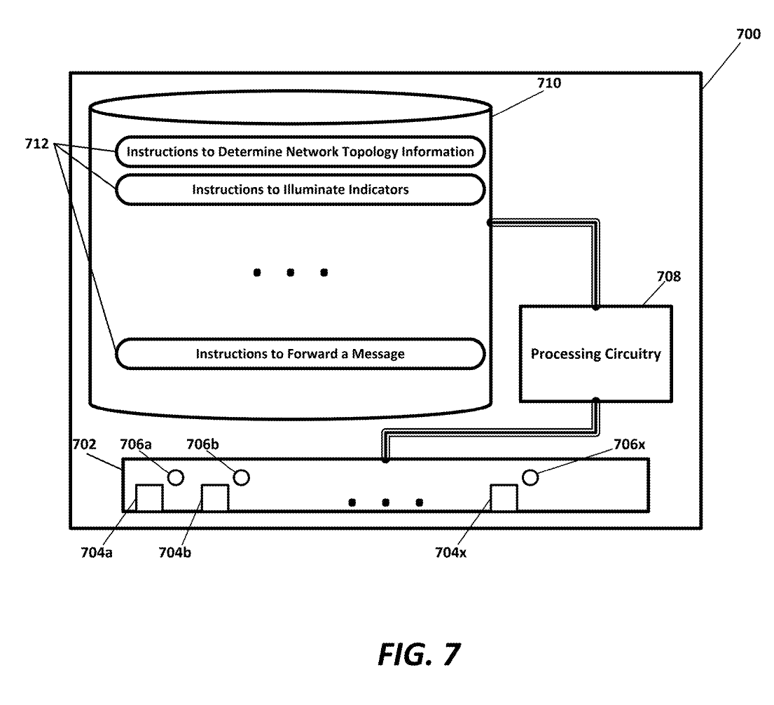

FIG. 7 illustrates an example network infrastructure device. Network infrastructure device 700 includes an interface 702. Interface 702 contains ports 704a-704x, which may accept data connections to interconnect network infrastructure device 700 with other network infrastructure devices and computing devices. Interface 702 further includes indicators 706a-x, each of which correspond to a respective port 704a-x. Interface 702 is coupled to processing circuitry 708. Processing circuitry 708 is also coupled to computer-readable medium 710, which contains instructions 712. Instructions 712 are executed on processing circuitry 708. For example, certain instructions 712 are executed on processing circuitry 708 to receive and process a message at interface 702, determine network topology information about a high-performance computing network, illuminate indicators 706, and forward the message through a port 704 of interface 702.

Although the present disclosure has been described in detail, it should be understood that various changes, substitutions and alterations can be made without departing from the spirit and scope of the disclosure. Any use of the words “may” or “can” in respect to features of the disclosure indicates that certain examples include the feature and certain other examples do not include the feature, as is appropriate given the context. Any use of the words “or” and “and” in respect to features of the disclosure indicates that examples can contain any combination of the listed features, as is appropriate given the context.

1. A device to:
receive a command from a network manager, to identify a plurality of ports associated with a first network infrastructure device; and
transmit a message through a high-performance computing network to the first network infrastructure device, comprising a request to illuminate indicators corresponding, respectively, to each port of the plurality of ports,
wherein the plurality of ports includes a first port of the first network infrastructure device and a second port of a second network infrastructure device.

2. The device of claim 1, wherein the high-performance computing network comprises a link including the first port and the second port.

3. The device of claim 1, wherein the plurality of ports includes a third port of the first network infrastructure device.

4. The device of claim 1, wherein the plurality of ports comprise ports associated with links between the first network infrastructure device and the second network infrastructure device.

5. The device of claim 1, wherein the request specifies a port number and local ID for each of the plurality of ports.

6. The device of claim 1, wherein the request specifies a LID associated with the first network infrastructure device.

7. The device of claim 1, wherein the request specifies a first LID for the first network infrastructure device and a second LID for the second network infrastructure device.

8. A system comprising:
a first switch; and
a second switch to:
receive a message transmitted through the high-performance computing network, the message comprising a request to illuminate indicators corresponding, respectively, to each port of a plurality of ports;
determine based on the message and network topology information a subset of the plurality of ports, including a first port, corresponding to the second switch;
illuminate indicators corresponding, respectively, to each port of the subset of the plurality of ports, including the first port; and
forward the message through the high-performance computing network to the first switch.

9. The system of claim 8, wherein the network topology information comprises a source local ID (LID) of a link, a source port of the link, a destination LID of the link, and a destination port of the link.

10. The system of claim 9, wherein forwarding the message through the high-performance computing network comprises forwarding the message through the link.

11. The system of claim 9, wherein the source LID corresponds to the second switch.

12. The system of claim 11, wherein the destination LID corresponds to the first switch.

13. The system of claim 9, wherein illuminating indicators corresponding, respectively, to each port of the subset of the plurality of ports comprises illuminating an indicator corresponding to the source port.

14. A method for identifying ports associated with a first switch, comprising:
receiving a message at a first port of a second switch, the message comprising a request to illuminate indicators corresponding, respectively, to each port of a plurality of ports associated with the first switch;
determining network topology information comprising a source local ID (LID) of a link, a source port of the link, a destination LID of the link, and a destination port of the link;
determining, based on the message and the network topology information, that the plurality of ports includes the source port and that the source port is a port of the second switch;
illuminating an indicator corresponding to the source port based on the determination that the source port is one of the plurality of ports and that the source port is a port of the second switch; and
forwarding the message through the first link.

15. The method of claim 14, wherein the destination LID of the link corresponds to the first switch.

16. The method of claim 14, wherein the network topology information further comprises a second source LID of a second link, a second source port of the second link, a second destination LID of the second link, and a second destination port of the second link.

17. The method of claim 16, further comprising:
determining, based on the message and the network topology information, that the second source port is one of the plurality of ports and the second source port is a port of the second switch;
illuminating an indicator corresponding to the second source port based on the determination that the second source port is one of the plurality of ports and that the second source port is a port of the second switch; and
forwarding the message through the second link.

18. The method of claim 14, wherein second destination LID corresponds to the first switch.

19. The method of claim 14, wherein the first port of the second switch is a port other than the source port.

20. The method of claim 16, wherein the request specifies a first LID corresponding to the first switch and a second LID corresponding to the second switch.
